(19) United States
(12) Patent Application Publication
(10) Pub. No.: US 2023/0184465 A1
(43) Pub. Date: Jun. 15, 2023

(54) GEOTHERMAL POWER PLANT SYSTEM

(71) Applicant: FUJI ELECTRIC CO., LTD., Kawasaki-shi (JP)

(72) Inventors: Taichiro KATO, Musashino-city (JP); Shinya UI, Hachioji-city (JP); Yuuji FUJIMOTO, Yokosuka-city (JP)

(21) Appl. No.: 18/064,275

(22) Filed: Dec. 11, 2022

(30) Foreign Application Priority Data
Dec. 15, 2021 (JP) 2021-203141

(51) Int. Cl. F24T 50/00

(52) U.S. Cl. CPC F24T 50/00; F24T 2010/56

(57) ABSTRACT

Provided is a geothermal power plant system configured to generate power by treating heat source water, including: a cyclone solid-liquid separation unit configured to separate solid substances inside the heat source water from the heat source water; and a heat exchanging unit configured to perform heat exchange on the heat source water from the cyclone solid-liquid separation unit. The geothermal power plant system may include a gas-liquid separation unit configured to separate gaseous substances from heat source water supplied to the cyclone solid-liquid separation unit.

The contents of the following Japanese patent application(s) are incorporated herein by reference:

NO. 2021-203141 filed in JP on Dec. 15, 2021

### BACKGROUND

### 1. Technical Field

The present invention relates to a geothermal power plant system.

### 2. Related Art

Conventionally, a geothermal power plant system is known to treat high-temperature heat source water in geothermal heat and generate power (see, for example, Patent Documents 1 and 2).

Patent Document 1: Japanese Patent Application Publication No. H11-239702

Patent Document 2: Japanese Patent Application Publication No. 2019-196854

### BRIEF DESCRIPTION OF THE DRAWINGS

FIG. 1 illustrates an example of a geothermal power plant system 100 during operation according to a comparative example.

FIG. 2 illustrates an example of a geothermal power plant system 200 during operation according to an example embodiment.

FIG. 3 illustrates an example of a geothermal power plant system 300 during operation according to an example embodiment.

FIG. 4 illustrates an example of a geothermal power plant system 400 during operation according to an example embodiment.

FIG. 5 illustrates an example of a geothermal power plant system 500 during operation according to an example embodiment.

FIG. 6 illustrates an example of a geothermal power plant system 600 during operation according to an example embodiment.

FIG. 7 illustrates an example of a geothermal power plant system 700 during operation according to an example embodiment.

FIG. 8 illustrates an example of a geothermal power plant system 800 during operation according to an example embodiment.

FIG. 9 illustrates an example of a geothermal power plant system 900 during operation according to an example embodiment.

FIG. 10 illustrates an example of the geothermal power plant system 900 when the operation is stopped according to an example embodiment.

FIG. 11 illustrates an example of a geothermal power plant system 1000 during operation according to an example embodiment.

FIG. 12 illustrates an example of the geothermal power plant system 1000 when the operation is stopped according to an example embodiment.

FIG. 13 illustrates an example of a geothermal power plant system 1100 during operation according to an example embodiment.

FIG. 14 illustrates an example of a geothermal power plant system 1200 during operation according to an example embodiment.

FIG. 15 illustrates an example of a geothermal power plant system 1300 during operation according to an example embodiment.

FIG. 16 illustrates an example of a geothermal power plant system 1400 during operation according to an example embodiment.

### DESCRIPTION OF EXEMPLARY EMBODIMENTS

Hereinafter, the present invention will be described through embodiments of the invention, but the following embodiments do not limit the claimed invention. In addition, not all of the combinations of features described in the embodiments are essential to the solution of the invention.

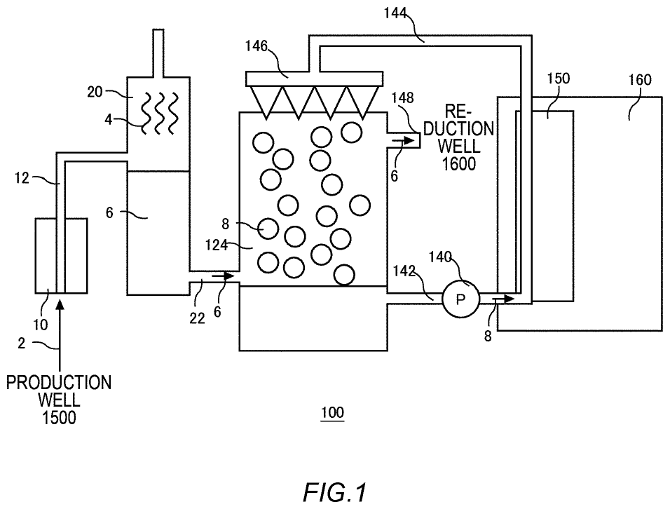

FIG. 1 illustrates an example of a geothermal power plant system 100 during operation according to a comparative example. In FIG. 1, a geothermal power plant system described in Patent Document 2 is shown. The geothermal power plant system 100 includes a geothermal fluid supply unit 10, a geothermal fluid supply pipe 12, a gas-liquid separation unit 20, a heat source water supply pipe 22, a heat exchanging unit 124, a pump 140, a heat medium supply pipe 142, a heat medium recovery pipe 144, a heat medium feed unit 146, a heat source water discharge pipe 148, a evaporation unit 150 and a binary power generation unit 160.

The geothermal power plant system 100 treats a geothermal fluid 2 supplied from a production well 1500. The geothermal fluid 2 is a high-temperature, high-pressure fluid in the ground. In the present example, the geothermal fluid 2 includes gaseous substances 4 or heat source water 6. The production well 1500 is a well that pumps the geothermal fluid 2 from an underground geothermal reservoir. The geothermal power plant system 100 treats the geothermal fluid 2 and performs power generation. Also, the geothermal power plant system 100 separates the heat source water 6 from the geothermal fluid 2, and performs power generation by treating the heat source water 6. In the present specification, a state for performing power generation by treating the geothermal fluid 2 or the heat source water 6 in the geothermal power plant system is referred to as “operation”. In FIG. 1, the state where the geothermal power plant system 100 is under operation is shown.

The geothermal fluid supply unit 10 supplies the geothermal fluid 2 to the geothermal power plant system 100. In the present example, the geothermal fluid supply unit 10 supplies the geothermal fluid 2 to the gas-liquid separation unit 20 via the geothermal fluid supply pipe 12. In a flow path of the geothermal fluid 2, the geothermal fluid supply pipe 12 may be provided between the geothermal fluid supply unit 10 and the gas-liquid separation unit 20.

The gas-liquid separation unit 20 performs gas-liquid separation on the geothermal fluid 2. The gas-liquid separation unit 20 separates the gaseous substances 4 from the heat source water 6 supplied to the heat exchanging unit 124. The heat source water 6 is a high-temperature liquid such as water, as an example. The gaseous substances 4 are water vapor or the like, as an example. The gaseous substances 4 may be supplied to a power generation apparatus that is not shown. The power generation apparatus may have a turbine. The power generation apparatus may generate power by rotating the turbine blades with gaseous substances 4. In the present example, the gas-liquid separation unit 20 supplies the heat source water 6 to the heat exchanging unit 124 via the heat source water supply pipe 22. In the flow path of the heat source water 6, the heat source water supply pipe 22 may be provided between the gas-liquid separation unit 20 and the heat exchanging unit 124.

The heat exchanging unit 124 performs heat exchange between the heat source water 6 and another heat medium. In the present example, the heat exchanging unit 124 performs heat exchange between the heat source water 6 and the heat medium 8. The heat medium 8 may be a hydrophobic liquid with a specific gravity different from that of the heat source water 6. In the present example, the heat medium 8 is a liquid with a greater specific gravity than that of the heat source water 6. The heat exchanging unit 124 supplies the heat medium 8 to the evaporation unit 150 via the heat medium supply pipe 142. In the flow path of the heat medium 8, the heat medium supply pipe 142 may be provided between the heat exchanging unit 124 and the evaporation unit 150. A pump 140 may be provided in the heat medium supply pipe 142 in order to supply the heat medium 8. The pump 140 supplies the heat medium 8 to the evaporation unit 150.

The heat exchanging unit 124 may discharge the heat source water 6 via the heat source water discharge pipe 148. The heat exchanging unit 124 may discharge the heat source water 6 to the reduction well 1600 via the heat source water discharge pipe 148. The reduction well 1600 is a well that returns the vapor and the hot liquid used for power generation to the underground geothermal reservoir.

The heat medium 8 is supplied to the evaporation unit 150. Accordingly, the evaporation unit 150 is heated by the heat medium 8. The evaporation unit 150 may cause the evaporation of a heat medium (assumed to be a binary heat medium), which is not shown with the heat of the heat medium 8. The binary heat medium is a liquid with a lower boiling point than that of water, such as ammonia water. The binary power generation unit 160 may generate power with the binary heat medium evaporated by the evaporation unit 150. The binary power generation unit 160 may have a turbine. The power generation apparatus may generate power by rotating the turbine blades with the binary heat medium evaporated by the evaporation unit 150.

The evaporation unit 150 supplies the heat medium 8 to the heat medium feed unit 146 via the heat medium recovery pipe 144. In the flow path of the heat medium 8, the heat medium recovery pipe 144 may be provided between the evaporation unit 150 and the heat medium feed unit 146. The heat medium feed unit 146 returns the heat medium 8 back to the heat exchanging unit 124.

In the geothermal power plant system 100, the precipitation of the solid substances such as scale may be a problem. Scale is a component included in water. Scale includes silica scale, calcium scale and so on. Since the heat medium 8, which is different from the heat source water 6, is supplied to the evaporation unit 150, the geothermal power plant system 100 can suppress the precipitation of scale in the evaporation unit 150.

However, in the geothermal power plant system 100, even if the heat medium 8 is hydrophobic, it is difficult to completely suppress the uptake of moisture. Accordingly, the heat medium 8 is likely to contain scale components. Therefore, in the evaporation unit 150, the precipitation of scale may occur. Also, the heat medium 8 may be supplied to the evaporation unit 150 in a state where the separation between the heat source water 6 and the heat medium 8 in the heat exchanging unit 124 is insufficient. Also in this case, the precipitation of scale in the evaporation unit 150 may occur. Accordingly, it is preferable to provide a structure to suppress the precipitation of scale due to the heat medium 8.

Furthermore, the heat source water 6 contains silica particles, grown scale particles, sands and so on (assumed to be solid substances) suspended in an undissolved state. Since the solid substances have a greater specific gravity than that of the heat medium 8, the solid substances may be mixed with the heat medium 8 and supplied to the evaporation unit 150. The solid substances may be considered to be removed with a mesh filter, but the use of a filter may cause clogging. Therefore, it is preferable to provide a structure other than a filter that can separate solid substances from the heat medium 8.

Also, in the geothermal power plant system 100, since the heat medium 8 is used, the system is complex and expensive. Cost reduction is important to shorten the payback period for the geothermal power plant system.

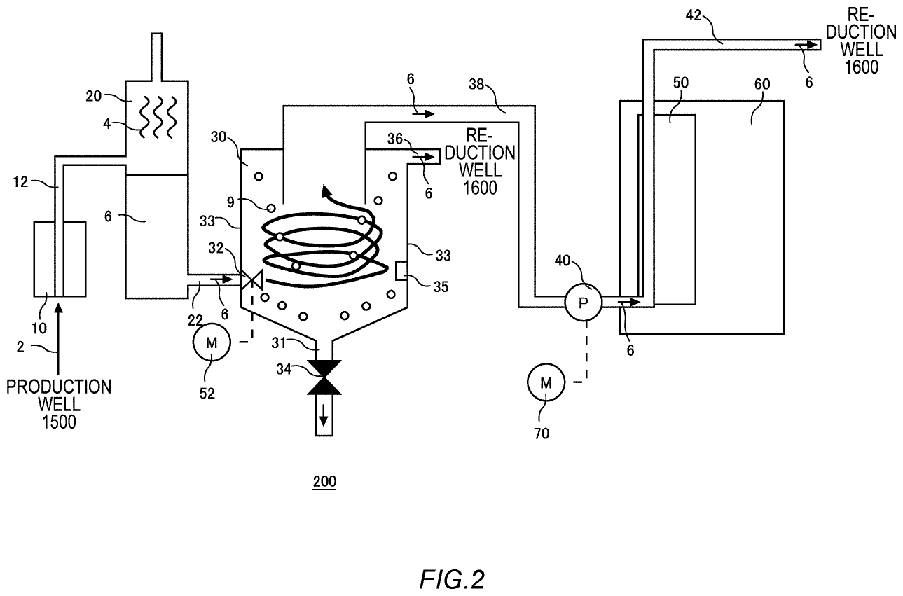

FIG. 2 illustrates an example of a geothermal power plant system 200 during operation according to an example embodiment. The geothermal power plant system 200 includes a geothermal fluid supply unit 10, a geothermal fluid supply pipe 12, a gas-liquid separation unit 20, a heat source water supply pipe 22, a cyclone solid-liquid separation unit 30, a control valve 32, a control valve 34, a flow velocity sensor 35, a heat source water discharge pipe 36, a heat source water supply pipe 38, a water pump 40, a heat source water discharge pipe 42, a heat exchanging unit 50, a flow velocity controlling unit 52, a binary power generation unit 60 and a driving controlling unit 70. The descriptions of labels in FIG. 2 that are identical to FIG. 1 are omitted.

In the present example, the gas-liquid separation unit 20 supplies the heat source water 6 to the cyclone solid-liquid separation unit 30. In the flow path of the heat source water 6, the heat source water supply pipe 22 may be provided between the gas-liquid separation unit 20 and the cyclone solid-liquid separation unit 30. The gas-liquid separation unit 20 separates the gaseous substances 4 from the heat source water 6 supplied to the cyclone solid-liquid separation unit 30.

The cyclone solid-liquid separation unit 30 separates the solid substances 9 inside the heat source water 6 from the heat source water 6. The solid substances 9 are silica particles, grown scale particles, sands and so on. The heat source water 6 supplied to the cyclone solid-liquid separation unit 30 swirls inside the cyclone solid-liquid separation unit 30 as shown in FIG. 2. Accordingly, the solid substances 9 impact on the side wall 33 of the cyclone solid-liquid separation unit 30 by centrifugal force. The side wall 33 of the cyclone solid-liquid separation unit 30 is a wall approximately parallel to the height direction of the cyclone solid-liquid separation unit 30. The solid substances 9 impacted on the side wall 33 are deposited at a bottom 31 of the cyclone solid-liquid separation unit 30. The bottom 31 of the cyclone solid-liquid separation unit 30 may be a region provided in the cyclone solid-liquid separation unit 30, between the control valve 34 and the side wall 33. Also, in the cyclone solid-liquid separation unit 30, a flow velocity sensor 35 may be provided to measure a swirling flow velocity of the heat source water 6.

In the present example, the control valve 32 is provided in the heat source water supply pipe 22. The flow velocity controlling unit 52 controls the control valve 32. The flow velocity controlling unit 52 may control the opening degree of the control valve 32. The flow velocity controlling unit 52 may control the swirling flow velocity of the heat source water 6 supplied to the cyclone solid-liquid separation unit 30 by controlling the opening degree of the control valve 32. In the present example, the control valve 32 is opened. In the present specification, the control valve is indicated by white fill when opened and indicated by black fill when closed.

The control valve 34 is provided at the bottom 31 of the cyclone solid-liquid separation unit 30. The control valve 34 may be controlled by a controlling unit, which is not shown. By controlling the control valve 34, the solid substances 9 deposited at the bottom 31 of the cyclone solid-liquid separation unit 30 can be discharged. In the present example, the control valve 34 is closed. The control valve 34 may be opened appropriately during operation of the geothermal power plant system 200.

The cyclone solid-liquid separation unit 30 supplies the heat source water 6 to the evaporation unit 150 via the heat source water supply pipe 38. In the flow path of the heat source water 6, the heat source water supply pipe 38 may be provided between the cyclone solid-liquid separation unit 30 and the heat exchanging unit 50. The water pump 40 may be provided to the heat source water supply pipe 38 in order to supply the heat source water 6. The water pump 40 may be provided between the cyclone solid-liquid separation unit 30 and the heat exchanging unit 50 in the flow path of the heat source water 6. The water pump 40 may supply the heat source water 6 to the heat exchanging unit 50. The driving controlling unit 70 may control the operation of the water pump 40. Note that the driving controlling unit 70 and the flow velocity controlling unit 52 may be one controlling unit.

The heat source water 6 is supplied to the heat source water supply pipe 38 provided above the cyclone solid-liquid separation unit 30. In the present specification, “upper”, “lower”, “above” and “below” indicate a position in a height direction from the bottom 31 of the cyclone solid-liquid separation unit 30 toward the heat source water supply pipe 38. A portion of the heat source water supply pipe 38 may be provided at least in the center of the swirling direction of the heat source water 6. The heat source water supply pipe 38 may be provided on the center side of the cyclone solid-liquid separation unit 30. The center of the cyclone solid-liquid separation unit 30 is the center in a direction connecting two side walls 33 of the cyclone solid-liquid separation unit 30. The position where the heat source water supply pipe 38 is provided may be above the control valve 34.

The cyclone solid-liquid separation unit 30 may discharge the heat source water 6 via the heat source water discharge pipe 36. The cyclone solid-liquid separation unit 30 may discharge the heat source water 6 to the reduction well 1600 via the heat source water discharge pipe 36.

The heat source water 6 may be supplied to the heat exchanging unit 50. The heat exchanging unit 50 performs heat exchange on the heat source water 6 from the cyclone solid-liquid separation unit 30. Performing heat exchange on the heat source water 6 from the cyclone solid-liquid separation unit 30 may be obtaining thermal energy from the heat source water 6. Therefore, the heat exchanging unit 50 is heated by the heat source water 6. The heat exchanging unit 50 may cause the evaporation of a binary heat medium, which is not shown, with the heat of the heat source water 6. The binary power generation unit 60 may generate power with the binary heat medium evaporated by the heat exchanging unit 50. The binary power generation unit 60 may have a turbine. The power generation apparatus may generate power by rotating the turbine blades with the binary heat medium evaporated by the heat exchanging unit 50.

The heat exchanging unit 50 discharges the heat source water 6 to the reduction well 1600 via the heat source water discharge pipe 42. In the flow path of the heat source water 6, the heat source water discharge pipe 42 may be provided between the heat exchanging unit 50 and the reduction well 1600.

In the present example, the geothermal power plant system 200 includes a cyclone solid-liquid separation unit 30 configured to separate the solid substances 9 inside the heat source water 6 from the heat source water 6. Accordingly, unlike the geothermal power plant system 200 in FIG. 1, the heat medium 8 is not used. Therefore, the structure for suppressing the precipitation of scale without using the heat medium 8 can be provided. Also, since the cyclone solid-liquid separation unit 30 causes no clogging unlike a filter or the like, it can stably remove the solid substances 9. Furthermore, since the heat medium 8 is not used, the system can become simpler, and the cost can be reduced.

Also, in the present example, the flow velocity controlling unit 52 controls the swirling flow velocity of the heat source water 6 supplied to the cyclone solid-liquid separation unit 30. The flow velocity controlling unit 52 controls the swirling flow velocity of the heat source water 6 supplied to the cyclone solid-liquid separation unit 30 by controlling the opening degree of the control valve 32. By increasing the swirling flow velocity, the separation efficiency of the heat source water 6 and the solid substances 9 can be increased. Note that if the swirling flow velocity is increased too much, the heat source water 6 may become turbulent, and conversely, the separation efficiency of the heat source water 6 and the solid substances 9 may decrease. Therefore, the operation of the water pump 40 may be controlled based on the swirling flow velocity of the heat source water 6. For example, the driving controlling unit 70 stops the operation of the water pump 40 when the swirling flow velocity of the heat source water 6 is equal to or greater than a constant flow velocity, which reduces the separation efficiency. Also, when the swirling flow velocity of the heat source water 6 is equal to or less than a constant flow velocity, the driving controlling unit 70 starts the operation of the water pump 40. The operation of the water pump 40 may be controlled by the loop controlling unit described below. Also, the swirling flow velocity of the heat source water 6 may be measured by the flow velocity sensor 35.

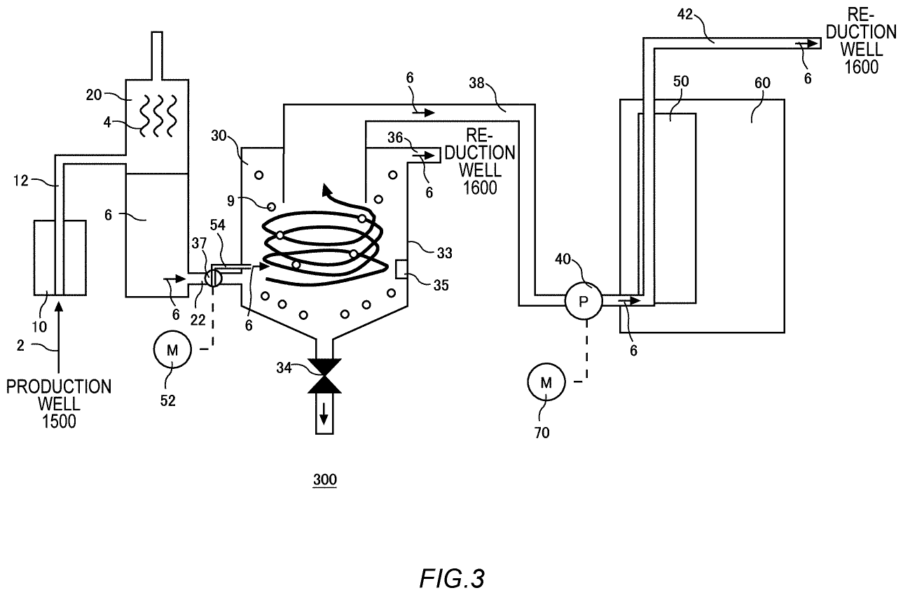

FIG. 3 illustrates an example of a geothermal power plant system 300 during operation according to an example embodiment. The geothermal power plant system 300 in FIG. 3 is different from the geothermal power plant system 200 in FIG. 2 in that it includes the switching valve 37 and the heat source water supply pipe 54. Also, the geothermal power plant system 300 in FIG. 3 is different from the geothermal power plant system 200 in FIG. 2 in the point of not including the control valve 32. The other configurations of the geothermal power plant system 300 in FIG. 3 may be the same as that of the geothermal power plant system 200 in FIG. 2. The descriptions of labels common to FIG. 2 in FIG. 3 are omitted.

In the present example, the gas-liquid separation unit 20 supplies the heat source water 6 to the heat exchanging unit 124 via the heat source water supply pipe 22 and the heat source water supply pipe 54. In the flow path of the heat source water 6, the heat source water supply pipe 54 may be provided between the gas-liquid separation unit 20 and the cyclone solid-liquid separation unit 30. The pipe diameter of the heat source water supply pipe 22 may be different from that of the heat source water supply pipe 54. The pipe diameter is the diameter of the pipe in a cross-section perpendicular to the direction in which the heat source water 6 flows. In the present example, the pipe diameter of the heat source water supply pipe 54 is less than that of the heat source water supply pipe 22. The heat source water supply pipe 54 may be connected to the heat source water supply pipe 22. The heat source water supply pipe 22 is an example of the first pipe, and the heat source water supply pipe 54 is an example of the second pipe.

The switching valve 37 is provided in the heat source water supply pipe 22 and the heat source water supply pipe 54. The switching valve 37 switches the flow path of the heat source water 6. In the present example, the switching valve 37 switches whether the heat source water 6 is supplied to the cyclone solid-liquid separation unit 30 from the heat source water supply pipe 22 or from the heat source water supply pipe 54. The pipe diameters of the heat source water supply pipe 22 and the heat source water supply pipe 54 are different. Accordingly, the flow velocity of the heat source water 6 supplied from the heat source water supply pipe 22 is different from the flow velocity of the heat source water 6 supplied from the heat source water supply pipe 54. By switching the flow path of the heat source water 6, the swirling flow velocity of the heat source water 6 supplied to the cyclone solid-liquid separation unit 30 can be controlled. The switching valve 37 may be controlled by the flow velocity controlling unit 52. In the present example, since the pipe diameter of the heat source water supply pipe 54 is less than that of the heat source water supply pipe 22, the flow velocity of the heat source water 6 supplied from the heat source water supply pipe 54 is greater than the flow velocity of the heat source water 6 supplied from the heat source water supply pipe 22. Note that since the pressure loss of the heat source water 6 supplied from the heat source water supply pipe 54 is high, it is preferable to switch the flow path of the heat source water 6 appropriately. The heat source water supply pipe 54 may constantly supply the heat source water 6.

In addition, although the switching valve 37 is provided in the present example, the control valves may also be provided in each of the heat source water supply pipe 22 and the heat source water supply pipe 54. Even in this case, the swirling flow velocity of the heat source water 6 can be controlled by the flow velocity controlling unit 52 controlling the control valves provided in each of them.

In the present example, at least a portion of the heat source water supply pipe 54 is provided above the heat source water supply pipe 22. The supply port of the heat source water supply pipe 54 may be provided above the supply port of the heat source water supply pipe 22. The supply port of the heat source water supply pipe is a place where the heat source water 6 is discharged from the heat source water supply pipe. By providing at least a portion of the heat source water supply pipe 54 above the heat source water supply pipe 22, the heat source water 6 can be supplied with a greater flow velocity on the upper side of the cyclone solid-liquid separation unit 30, and scale can be efficiently removed. In the present specification, the upper side of the cyclone solid-liquid separation unit 30 means being above the center of the height direction of the cyclone solid-liquid separation unit 30, and the lower side of the cyclone solid-liquid separation unit 30 means being below the center of the height direction of the cyclone solid-liquid separation unit 30.

Note that when providing the heat source water supply pipe on the upper side of the cyclone solid-liquid separation unit 30, the flow velocity of the supplied heat source water 6 may drop. Accordingly, it is preferable to provide the heat source water supply pipe on the lower side of the cyclone solid-liquid separation unit 30. When providing the heat source water supply pipe on the upper side of the cyclone solid-liquid separation unit 30, it is preferable not to reduce the flow velocity by providing the water pump in the heat source water supply pipe.

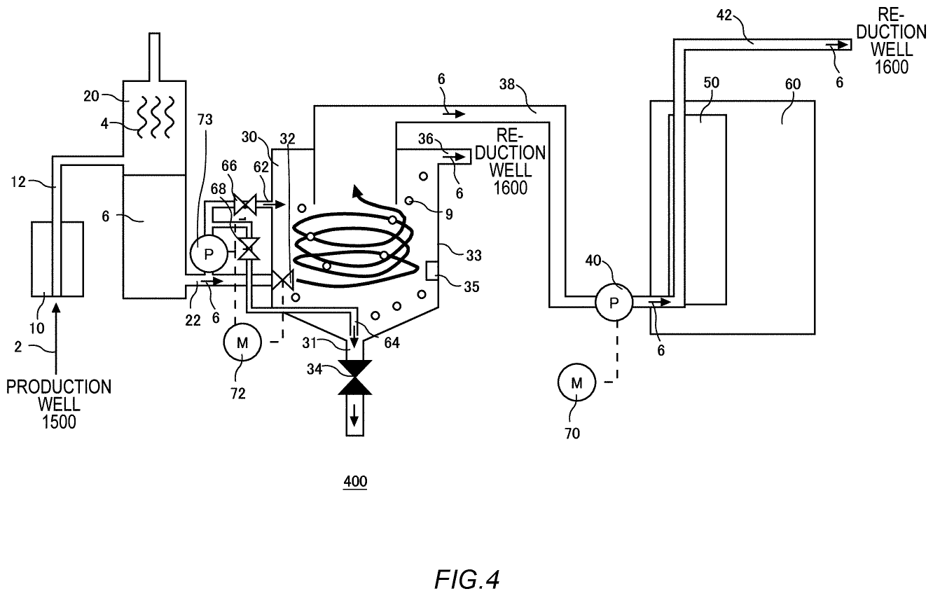

FIG. 4 illustrates an example of a geothermal power plant system 400 during operation according to an example embodiment. The geothermal power plant system 400 in FIG. 4 is different from the geothermal power plant system 200 in FIG. 2 in that it includes a nozzle 62, a nozzle 64, a control valve 66, a control valve 68, a nozzle controlling unit 72 and a water pump 73. The other configurations of the geothermal power plant system 400 in FIG. 4 may be the same as that of the geothermal power plant system 200 in FIG. 2. The descriptions of labels common to FIG. 2 in FIG. 4 are omitted.

The nozzle 62 is a nozzle for discharging the heat source water 6. In the present example, the nozzle 62 is provided on the upper side of the cyclone solid-liquid separation unit 30. On the upper side of the cyclone solid-liquid separation unit 30, especially near the heat source water supply pipe 38, the swirling flow velocity of the heat source water 6 is weakened and the temperature drops due to dissipation of heat, causing the scale to precipitate and easily adhere to the side walls 33 of the cyclone solid-liquid separation unit 30. Therefore, by providing the nozzle 62 on the upper side of the cyclone solid-liquid separation unit 30, scale on the upper side of the cyclone solid-liquid separation unit 30 can be removed. Since the nozzle 62 is provided on the upper side of the cyclone solid-liquid separation unit 30, it is preferable not to reduce the flow velocity by providing the water pump 73.

Similarly, the nozzle 64 is a nozzle for discharging the heat source water 6. In the present example, the nozzle 64 is provided on the lower side of the cyclone solid-liquid separation unit 30. On the lower side of the cyclone solid-liquid separation unit 30, especially near the bottom 31, the heat source water 6 stays and the temperature drops due to dissipation of heat, causing the scale to precipitate and easily adhere to the side walls 33 of the cyclone solid-liquid separation unit 30. Therefore, by providing the nozzle 64 on the lower side of the cyclone solid-liquid separation unit 30, scale on the lower side of the cyclone solid-liquid separation unit 30 can be removed. Note that in the nozzle 64, the water pump 73 may be provided.

The nozzle controlling unit 72 may control the control valve 66, the control valve 68 and the water pump 73. The nozzle controlling unit 72 may control the discharge of the heat source water 6 at the nozzle 62 by controlling the control valve 66. The nozzle controlling unit 72 may control the discharge of the heat source water 6 at the nozzle 64 by controlling the control valve 68. Also, the nozzle controlling unit 72 may function as a flow velocity controlling unit.

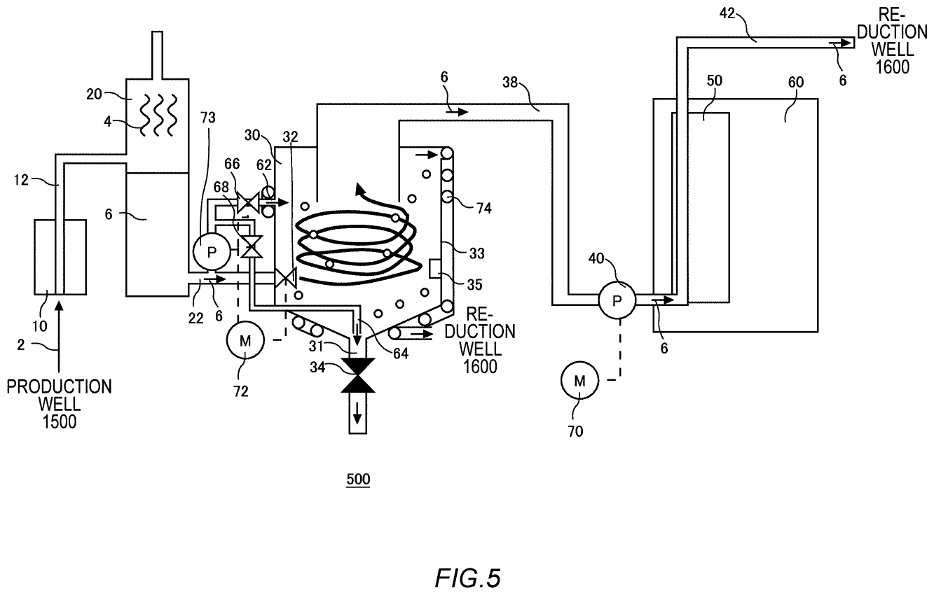

FIG. 5 illustrates an example of a geothermal power plant system 500 during operation according to an example embodiment. The geothermal power plant system 500 in FIG. 5 is different from the geothermal power plant system 400 in FIG. 4 in that it includes a spiral piping 74. The other configurations of the geothermal power plant system 500 in FIG. 5 may be the same as that of the geothermal power plant system 400 in FIG. 4. The descriptions of labels common to FIG. 4 in FIG. 5 are omitted.

The spiral piping 74 discharges the heat source water 6 to the reduction well 1600. In the present example, the spiral piping 74 is provided so as to enclose the cyclone solid-liquid separation unit 30. The spiral piping 74 is provided to make at least one circuit around the cyclone solid-liquid separation unit 30 inside the plane perpendicular to the vertical direction. In the example in FIG. 5, the spiral piping 74 is located in a partial region in the vertical direction of the cyclone solid-liquid separation unit 30 to enclose the cyclone solid-liquid separation unit 30. The spiral piping 74 may be provided over the entire in the vertical direction of the cyclone solid-liquid separation unit 30. The spiral piping 74 may be provided so as to be in contact with the cyclone solid-liquid separation unit 30. Heat may be dissipated from the piping until it is returned to the reduction well 1600. The scale deposition occurs when the temperature of the heat source water 6 drops. In the present example, by providing the spiral piping 74 being in contact with the cyclone solid-liquid separation unit 30, heat from the cyclone solid-liquid separation unit 30 can suppress the dissipation of heat from the spiral piping 74 and prevent the scale deposition. In order to conduct heat from the cyclone solid-liquid separation unit 30, the material of the spiral piping 74 is preferably a material with high thermal conductivity such as a metal. The material of the spiral piping 74 is carbon steel or stainless steel as an example. Note that the dissipation of heat is suppressed, the portion of the spiral piping 74 that is not in contact with the cyclone solid-liquid separation unit 30 is preferably covered by a thermally insulating material with low thermal conductivity.

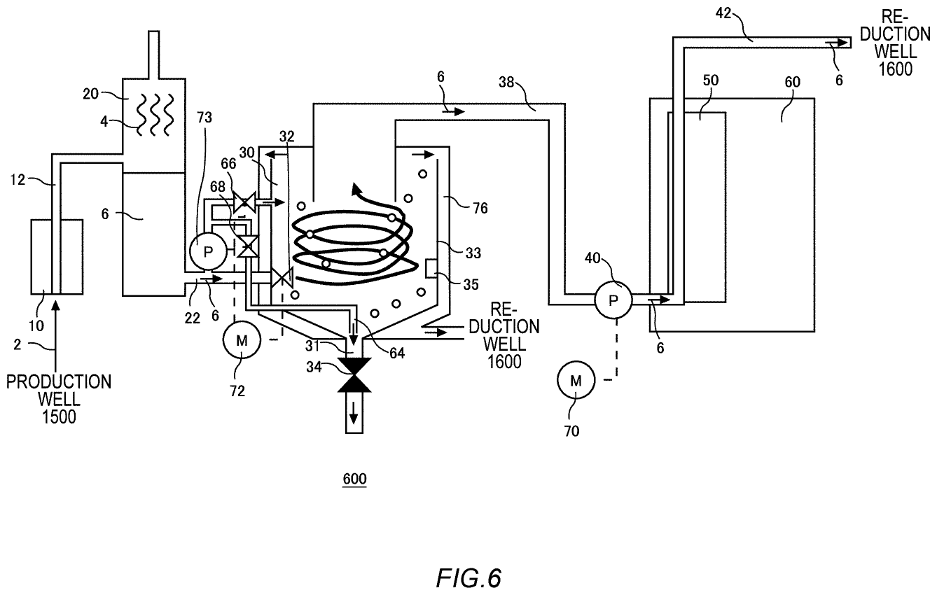

FIG. 6 illustrates an example of a geothermal power plant system 600 during operation according to an example embodiment. The geothermal power plant system 600 in FIG. 6 is different from the geothermal power plant system 400 in FIG. 4 in that it includes a dual pipe 76. The other configurations of the geothermal power plant system 600 in FIG. 6 may be the same as that of the geothermal power plant system 400 in FIG. 4. The descriptions of labels common to FIG. 4 in FIG. 6 are omitted.

The dual pipe 76 discharges the heat source water 6 to the reduction well 1600. The dual pipe 76 is provided inside the cyclone solid-liquid separation unit 30. By providing the dual pipe 76 provided inside the cyclone solid-liquid separation unit 30, the dissipation of heat from the dual pipe 76 can be suppressed with the heat from the cyclone solid-liquid separation unit 30 on an inner side than the dual pipe 76, and the scale deposition can be prevented. The dual pipe 76 may be formed of the same material as the cyclone solid-liquid separation unit 30. In order to conduct heat from the cyclone solid-liquid separation unit 30, the material of the dual pipe 76 is preferably a material with high thermal conductivity such as metal.

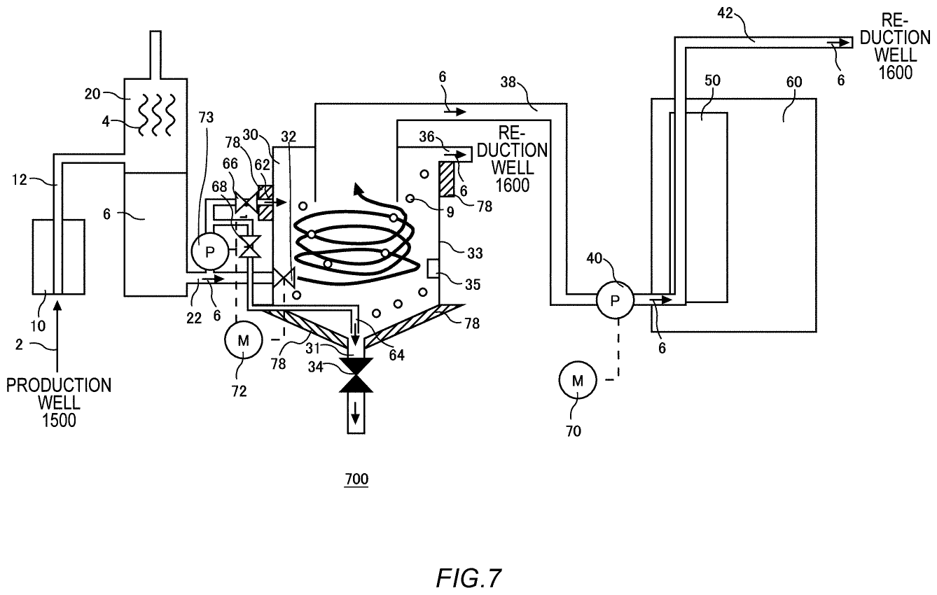

FIG. 7 illustrates an example of a geothermal power plant system 700 during operation according to an example embodiment. The geothermal power plant system 700 in FIG. 7 is different from the geothermal power plant system 400 in FIG. 4 in that it includes the thermally insulating material 78. The other configurations of the geothermal power plant system 700 in FIG. 7 may be the same as that of the geothermal power plant system 400 in FIG. 4. The descriptions of labels common to FIG. 4 in FIG. 7 are omitted.

The thermally insulating material 78 is a material with a low thermal conductivity. The thermally insulating material 78 may be a generally used material such as glass wool and rock wool. In the present example, the thermally insulating material 78 is provided to be in contact with the heat source water discharge pipe 36. By providing the thermally insulating material 78, the dissipation of heat from the piping can be suppressed, and the scale deposition can be prevented. The thermally insulating material 78 may be provided to be in contact with the nozzle 62. The thermally insulating material 78 may be provided to be in contact with the bottom 31. The thermally insulating material 78 is preferably provided to be in contact with a place where scale is easier to precipitate.

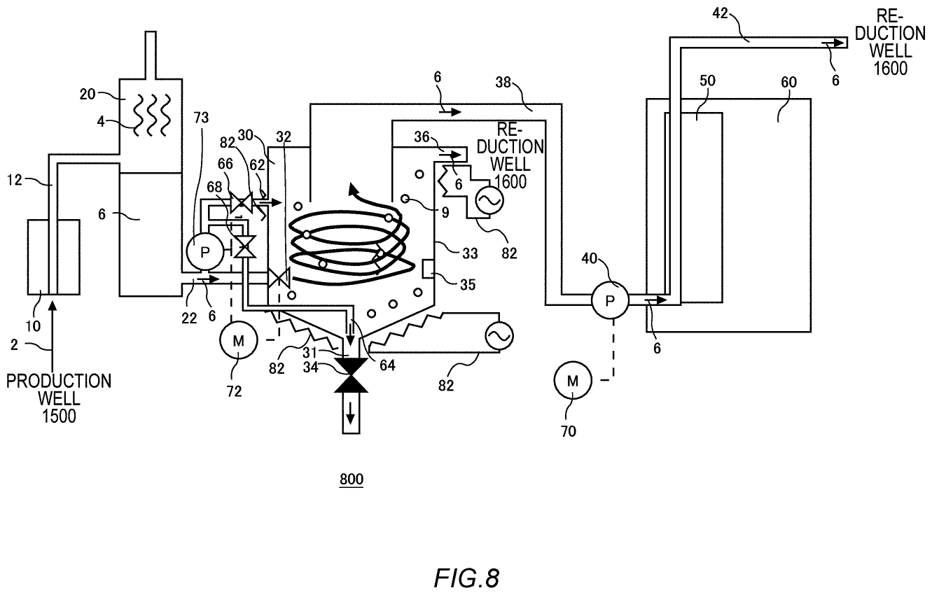

FIG. 8 illustrates an example of a geothermal power plant system 800 during operation according to an example embodiment. The geothermal power plant system 800 in FIG. 8 is different from the geothermal power plant system 400 in FIG. 4 in that it includes a heating unit 82. The other configurations of the geothermal power plant system 800 in FIG. 8 may be the same as that of the geothermal power plant system 400 in FIG. 4. The descriptions of labels common to FIG. 4 in FIG. 8 are omitted.

The heating unit 82 is configured to heat the heat source water discharge pipe 36 or the nozzle 62. The heating unit 82 may have a resistance. By applying a voltage on a resistance of the heating unit 82, the heating unit 82 may generate heat. In the present example, the heating unit 82 is provided to be in contact with the heat source water discharge pipe 36. By providing the heating unit 82, the dissipation of heat from the piping can be suppressed, the scale deposition can be prevented. The heating unit 82 may be provided to be in contact with the nozzle 62. The heating unit 82 may be provided to be in contact with the bottom 31. The heating unit 82 is preferably provided to be in contact with a place where scale is easier to precipitate.

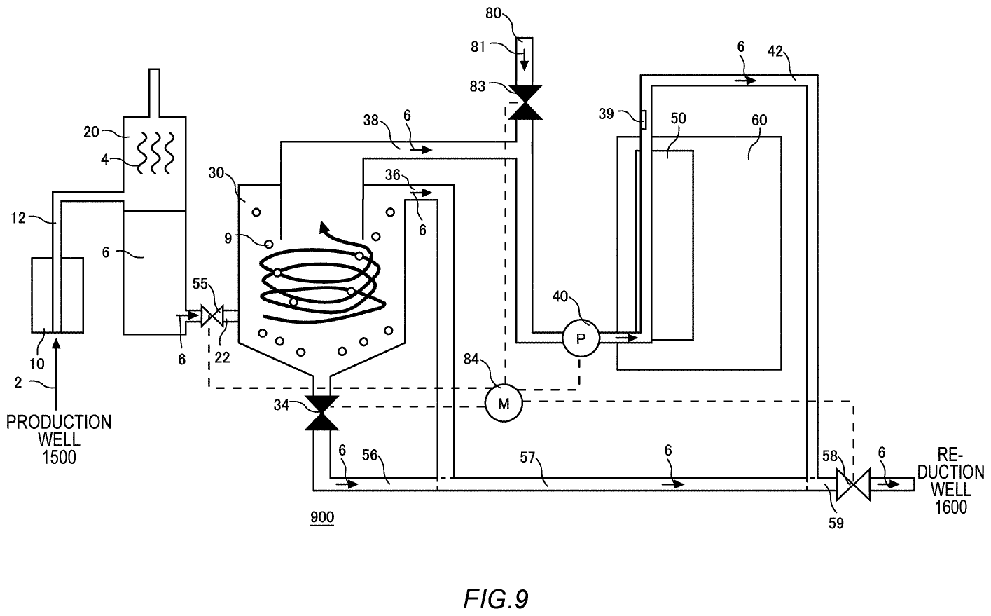

FIG. 9 illustrates an example of a geothermal power plant system 900 during operation according to an example embodiment. The geothermal power plant system 900 in FIG. 9 is different from the geothermal power plant system 200 in FIG. 2 in that it includes a temperature sensor 39, a control valve 55, a heat source water discharge pipe 56, a control valve 58, a detergent feed unit 80, a control valve 83 and a loop controlling unit 84. Also, the geothermal power plant system 900 in FIG. 9 is different from the geothermal power plant system 200 in FIG. 2 in the point of not including the control valve 32, the flow velocity sensor 35 and the flow velocity controlling unit 52. The other configurations of the geothermal power plant system 900 in FIG. 9 may be the same as that of the geothermal power plant system 200 in FIG. 2. The descriptions of labels common to FIG. 2 in FIG. 9 are omitted.

In the present example, the control valve 55 is provided in the heat source water supply pipe 22. The loop controlling unit 84 controls the control valve 55. The loop controlling unit 84 may control the opening degree of the control valve 55. In the present example, the loop controlling unit 84 controls whether the control valve 55 is in an opened state or the control valve 55 is in a closed state. In FIG. 9, the control valve 55 is opened.

The cyclone solid-liquid separation unit 30 discharges the solid substances 9 deposited at the bottom 31 of the cyclone solid-liquid separation unit 30 via the heat source water discharge pipe 56. The heat source water discharge pipe 56 may be provided between the bottom 31 of the cyclone solid-liquid separation unit 30 and the reduction well 1600.

Each of the heat source water discharge pipe 36, the heat source water discharge pipe 42 and the heat source water discharge pipe 56 has a common portion. In the present example, the portion from the connecting portion of the heat source water discharge pipe 36 and the heat source water discharge pipe 56, to the connecting portion of the heat source water discharge pipe 36 or the heat source water discharge pipe 56 and the heat source water discharge pipe 42 is regarded as a common portion 57. The heat source water discharge pipe 36 and the heat source water discharge pipe 56 share the common portion 57. The portion from the connecting portion of the heat source water discharge pipe 36 or the heat source water discharge pipe 56 and the heat source water discharge pipe 42, to the reduction well 1600 is regarded as a common portion 59. The heat source water discharge pipe 36, the heat source water discharge pipe 42 and the heat source water discharge pipe 56 share the common portion 59. In FIG. 9, the boundaries of the common portion 57 and the common portion 59 are illustrated with dotted lines.

In the present example, a control valve 58 is provided in the common portion 59. The loop controlling unit 84 controls the control valve 58. The loop controlling unit 84 may control the opening degree of the control valve 58. In the present example, the loop controlling unit 84 controls whether the control valve 58 is in an opened state, or the control valve 58 is in a closed state. In FIG. 9, the control valve 58 is opened.

The detergent feed unit 80 feeds a detergent 81 into the flow path of the heat source water 6. The detergent 81 may be hydrofluoric acid or the like. The detergent feed unit 80 may be provided in the heat source water supply pipe 38. The detergent feed unit 80 is provided between the cyclone solid-liquid separation unit 30 and the heat exchanging unit 50 in the flow path of the heat source water 6. In the present example, the detergent feed unit 80 is provided between the cyclone solid-liquid separation unit 30 and the water pump 40 in the flow path of the heat source water 6. The loop controlling unit 84 controls whether the control valve 83 is in an opened state or the control valve 83 is in a closed state. By controlling the control valve 83, the feed of the detergent 81 by the detergent feed unit 80 can be controlled. In FIG. 9, the control valve 83 is closed. In the present example, the water pump 40 is controlled by the loop controlling unit 84.

The temperature sensor 39 is provided in the heat source water discharge pipe 42. The temperature sensor 39 measures the temperature of the heat source water 6 discharged by the heat exchanging unit 50. The temperature sensor 39 may be near the heat exchanging unit 50 provided in the flow path of the heat source water 6. When scale inside the pipe precipitates, the efficiency of the heat exchange in the heat exchanging unit 50 decreases. Accordingly, by monitoring the temperature of the heat source water 6 discharged by the heat exchanging unit 50 with the temperature sensor 39, the precipitation amount of scale inside the pipe can be monitored. The temperature sensor 39 may output the temperature of the heat source water 6 to the detergent feed unit 80 or the loop controlling unit 84.

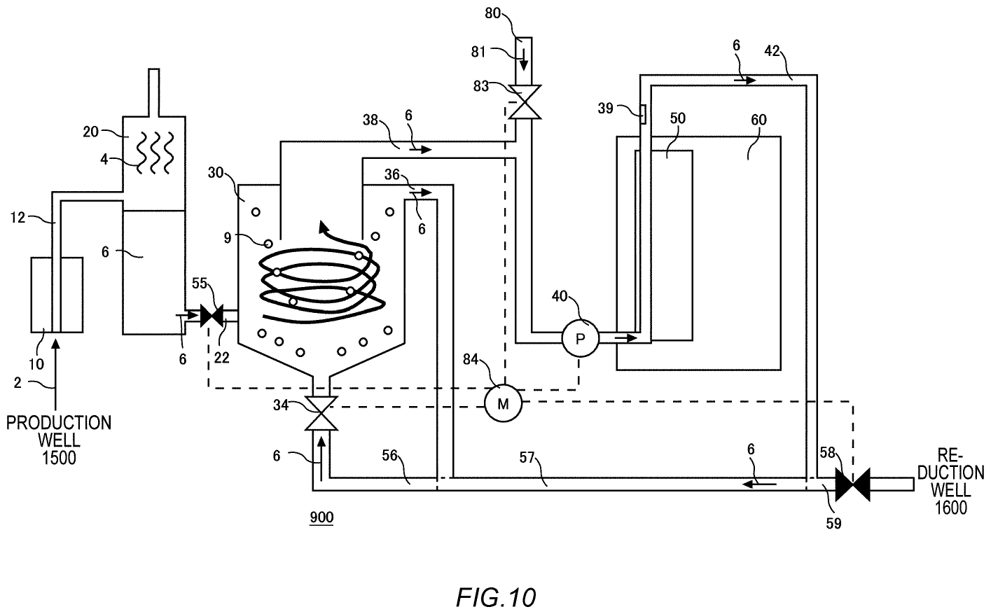

FIG. 10 illustrates an example of the geothermal power plant system 900 when the operation is stopped according to the example embodiment. In the present example, the control valve 55 is closed. In the present example, the control valve 58 is also closed. In addition, in the present example, the control valve 83 is opened.

In the present example, the loop controlling unit 84 forms a loop flow path including at least one of a heat exchanging unit 50 or a cyclone solid-liquid separation unit 30. In order to form a loop flow path including at least one of the heat exchanging unit 50 or the cyclone solid-liquid separation unit 30, the loop controlling unit 84 may control the control valve 55 and the control valve 58. In the geothermal power plant system 900, in order to form a loop flow path including both of the heat exchanging unit 50 and the cyclone solid-liquid separation unit 30, the loop controlling unit 84 controls the control valve 55 and the control valve 58. The loop flow path is a flow path of the circulating heat source water 6. By forming the loop flow path, the pipe can be cleaned, and the scale deposition can be suppressed.

In one loop flow path of the present example, the heat source water 6 flows through the cyclone solid-liquid separation unit 30, the heat source water supply pipe 38, the heat exchanging unit 50, the heat source water discharge pipe 42, the common portion 59, the common portion 57, the heat source water discharge pipe 56 and the cyclone solid-liquid separation unit 30 in order. Also, in one loop flow path of the present example, the heat source water 6 flows through the cyclone solid-liquid separation unit 30, the heat source water discharge pipe 36, the common portion 57, the heat source water discharge pipe 56 and the cyclone solid-liquid separation unit 30 in order.

The operation of the geothermal power plant system 900 when the operation is stopped is described. When the temperature of the heat source water 6 discharged by the heat exchanging unit 50, which is measured by the temperature sensor 39, has become a value equal to or greater than a defined value, the loop controlling unit 84 closes the control valve 55. Then, the loop controlling unit 84 opens the control valve 34. Then, the loop controlling unit 84 closes the control valve 58. Then, the loop controlling unit 84 opens the control valve 83. By opening the control valve 83, the detergent feed unit 80 can feed the detergent into the loop flow path, and can clean the pipe.

The operation of the geothermal power plant system 900 when the operation is started is described. When the temperature of the heat source water 6 discharged by the heat exchanging unit 50, which is measured by the temperature sensor 39, has become a value equal to or less than a defined value, the loop controlling unit 84 closes the control valve 83. Then, the loop controlling unit 84 opens the control valve 58. Then, the loop controlling unit 84 closes the control valve 34. Then, the loop controlling unit 84 opens the control valve 55. As described above, the operation of the geothermal power plant system 900 can be stopped and started automatically. Note that the timing when the operation of the geothermal power plant system 900 is started may be the timing when the discharge pressure of the water pump 40 has become a value equal to or less than a define pressure. The discharge pressure of the water pump 40 may be monitored by the loop controlling unit 84.

The detergent feed unit 80 may control the feed amount of the detergent 81 based on the temperature of the heat source water 6 discharged by the heat exchanging unit 50 (the output of the temperature sensor 39). For example, when the temperature of the heat source water 6 discharged by the heat exchanging unit 50 becomes equal to or greater than a predetermined temperature, the detergent feed unit 80 may start to feed the detergent 81. When the temperature of the heat source water 6 discharged by the heat exchanging unit 50 has become equal to or less than a predetermine temperature, the detergent feed unit 80 may stop feeding the detergent 81. Also, as the temperature of the heat source water 6 discharged by the heat exchanging unit 50 becomes higher, the detergent feed unit 80 may increase the feed amount of the detergent 81. By controlling the feed amount of the detergent 81 based on the temperature of the heat source water 6 discharged by the heat exchanging unit 50 (the output of the temperature sensor 39), the feed amount of the detergent 81 can be reduced. Also, the detergent feed unit 80 may feed the detergent 81 in a time-distributed manner so that the concentration of the detergent 81 is not locally high. That is, the detergent feed unit 80 may repeatedly alternate between a state in which the detergent 81 is feed and a state in which the detergent 81 is not feed.

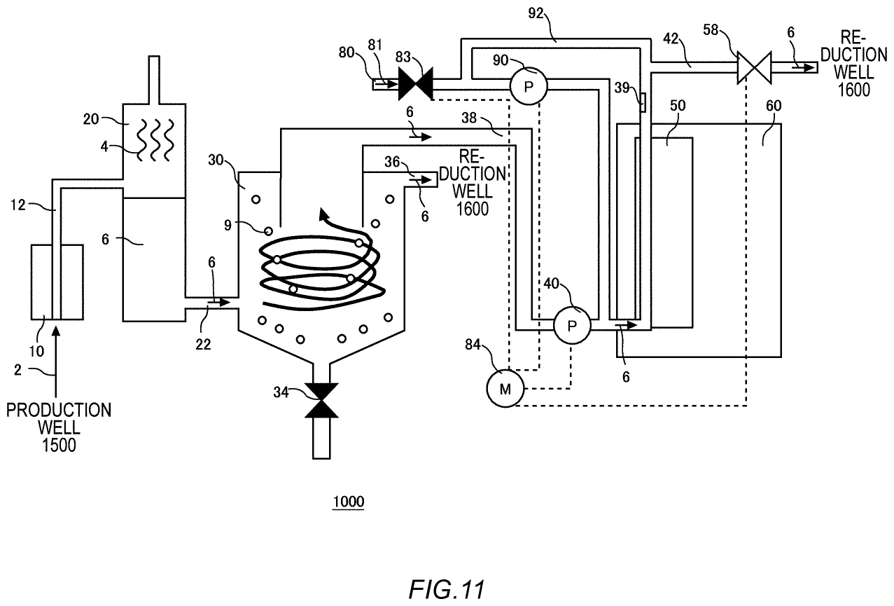

FIG. 11 illustrates an example of a geothermal power plant system 1000 during operation according to an example embodiment. The geothermal power plant system 1000 in FIG. 11 is different from the geothermal power plant system 200 in FIG. 2 in that it includes a temperature sensor 39, a control valve 58, a detergent feed unit 80, a control valve 83, a loop controlling unit 84 and a water pump 90. Also, the geothermal power plant system 1000 in FIG. 11 is different from the geothermal power plant system 200 in FIG. 2 in the point of not including the control valve 32, the flow velocity sensor 35 and the flow velocity controlling unit 52. The other configurations of the geothermal power plant system 1000 in FIG. 11 may be the same as that of the geothermal power plant system 200 in FIG. 2. The descriptions of labels common to FIG. 2 in FIG. 11 are omitted.

In the present example, the control valve 58 is provided in the heat source water discharge pipe 42. The loop controlling unit 84 controls the control valve 58. The loop controlling unit 84 may control the opening degree of the control valve 58. In the present example, the loop controlling unit 84 controls whether the control valve 58 is in an opened state, or the control valve 58 is in a closed state. In FIG. 11, the control valve 58 is opened.

In the present example, the connection tube 92 connects the heat source water supply pipe 38 and the heat source water discharge pipe 42. In the connection tube 92, a detergent feed unit 80 may be provided. The detergent feed unit 80 feeds a detergent 81 into the flow path of the heat source water 6. The detergent 81 may be hydrofluoric acid or the like. The loop controlling unit 84 controls whether the control valve 83 is in an opened state, or the control valve 83 is in a closed state. By controlling the control valve 83, the feed of the detergent 81 by the detergent feed unit 80 can be controlled. In FIG. 11, the control valve 83 is closed. Also, in the connection tube 92, a water pump 90 may be provided. In the present example, the water pump 90 is controlled by the loop controlling unit 84. The discharge pressure of the water pump 90 may be monitored by the loop controlling unit 84.

Similar to FIG. 10, the temperature sensor 39 is provided in the heat source water discharge pipe 42. The temperature sensor 39 measures the temperature of the heat source water 6 discharged by the heat exchanging unit 50. The temperature sensor 39 may be provided near the heat exchanging unit 50 in the flow path of the heat source water 6. The temperature sensor 39 may output the temperature of the heat source water 6 to the detergent feed unit 80 or the loop controlling unit 84.

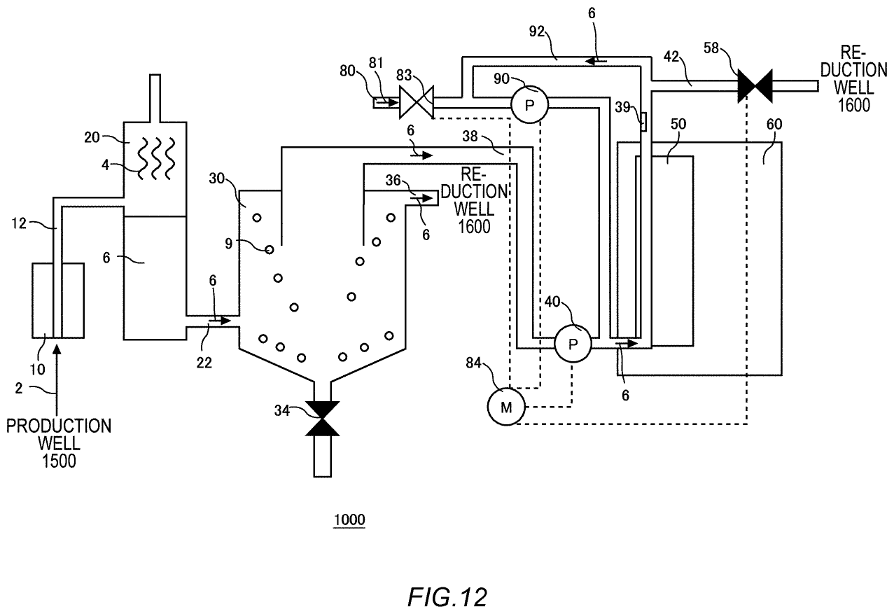

FIG. 12 illustrates an example of the geothermal power plant system 1000 when the operation is stopped according to an example embodiment. In the present example, the control valve 58 is closed. Also in the present example, the control valve 83 is opened.

In the present example, the loop controlling unit 84 forms a loop flow path including at least one of the heat exchanging unit 50 or the cyclone solid-liquid separation unit 30. The loop controlling unit 84 may control the control valve 58 so as to form the loop flow path including at least one of the heat exchanging unit 50 or the cyclone solid-liquid separation unit 30. In the geothermal power plant system 1000, the loop controlling unit 84 controls the control valve 58 so as to form the loop flow path including the heat exchanging unit 50 but not including the cyclone solid-liquid separation unit 30. By forming the loop flow path, the pipe can be cleaned, and the scale deposition can be suppressed. In the loop flow path of the present example, the heat source water 6 flows through the heat source water supply pipe 38, the heat exchanging unit 50, the heat source water discharge pipe 42, the connection tube 92 and the heat source water supply pipe 38 in order.

The operation of the geothermal power plant system 1000 when the operation is stopped is described. When the temperature of the heat source water 6 discharged by the heat exchanging unit 50, which is measured by the temperature sensor 39, has become a value equal to or greater than a defined value, the loop controlling unit 84 stops the water pump 40. Then, the loop controlling unit 84 closes the control valve 58. Then, the loop controlling unit 84 controls the water pump 90 to operate. Furthermore, the loop controlling unit 84 opens the control valve 83. By opening the control valve 83, the detergent feed unit 80 can feed the detergent 81 into the loop flow path and can clean the pipe.

The operation of the geothermal power plant system 1000 when the operation is started is described. When the temperature of the heat source water 6 discharged by the heat exchanging unit 50, which is measured by the temperature sensor 39, has become a value equal to or less than a defined value, the loop controlling unit 84 closes the control valve 83. Then, the loop controlling unit 84 stops the water pump 90. Then, the loop controlling unit 84 opens the control valve 58. Then, the loop controlling unit 84 controls the water pump 40 to operate. As described above, the operation of the geothermal power plant system 1000 can be stopped and started automatically. Note that the timing when the operation of the geothermal power plant system 1000 is started may be the timing when the discharge pressure of the water pump 90 has become a value equal to or less than a define pressure.

Also, similar to FIG. 10, in the geothermal power plant system 1000, the detergent feed unit 80 may control the feed amount of the detergent 81 based on the temperature of the heat source water 6 discharged by the heat exchanging unit 50 (the output of the temperature sensor 39).

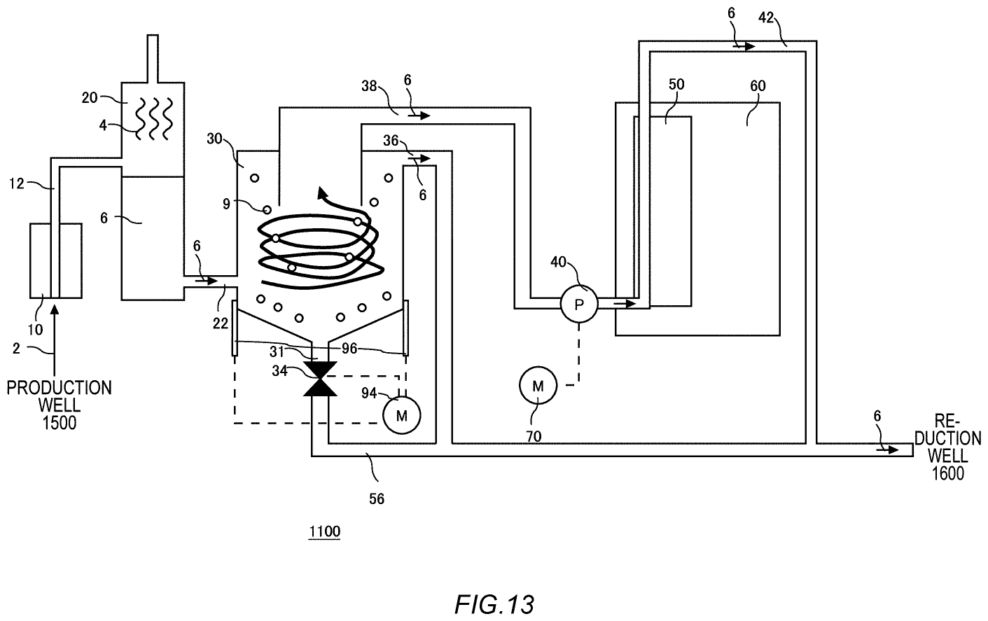

FIG. 13 illustrates an example of a geothermal power plant system 1100 during operation according to an example embodiment. The geothermal power plant system 1100 in FIG. 13 is different from the geothermal power plant system 200 in FIG. 2 in that it includes a heat source water discharge pipe 56, a bottom controlling unit 94 and a stress sensor 96. Also, the geothermal power plant system 1100 in FIG. 13 is different from the geothermal power plant system 200 in FIG. 2 in the point of not including the control valve 32, the flow velocity sensor 35 and the flow velocity controlling unit 52. The other configurations of the geothermal power plant system 1100 in FIG. 13 may be the same as that of the geothermal power plant system 200 in FIG. 2. The descriptions of labels common to FIG. 2 in FIG. 13 are omitted.

The stress sensor 96 measures the deposit amount of the solid substances 9 deposited at the bottom 31 of the cyclone solid-liquid separation unit 30. By measuring the compressive stress at the bottom 31 of the cyclone solid-liquid separation unit 30, the stress sensor 96 may measure the deposit amount of the solid substances 9 deposited at the bottom 31 of the cyclone solid-liquid separation unit 30. The stress sensor 96 may be a strain gage. The stress sensor 96 may output the deposit amount of the solid substances 9 to the bottom controlling unit 94.

The bottom controlling unit 94 may control the control valve 34. In the present example, the bottom controlling unit 94 (or the cyclone solid-liquid separation unit 30) controls the discharge amount of the solid substances 9 based on the deposit amount of the solid substances 9 deposited at the bottom 31 of the cyclone solid-liquid separation unit 30. For example, when the deposit amount of the solid substances 9 deposited at the bottom 31 of the cyclone solid-liquid separation unit 30 is equal to or greater than a defined value, the bottom controlling unit 94 opens the control valve 34 and discharges the solid substances 9. Also, when the deposit amount of the solid substances 9 deposited at the bottom 31 of the cyclone solid-liquid separation unit 30 is equal to or less than the defined value, the bottom controlling unit 94 closes the control valve 34 and stops discharging the solid substances 9. By controlling the discharge amount of the solid substances 9, the heat source water 6 can flow while the solid substances 9 are accumulated to some extent, and the solid substances 9 can flow together with the heat source water 6 at a high flow velocity to the heat source water discharge pipe 56, and scale adhering to the heat source water discharge pipe 56 can be washed away.

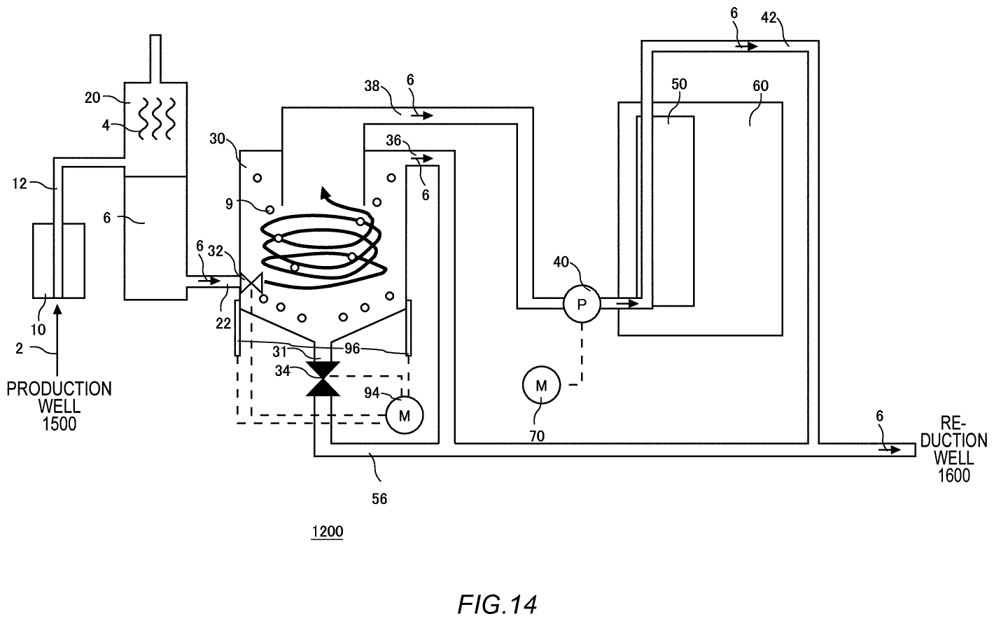

FIG. 14 illustrates an example of a geothermal power plant system 1200 during operation according to an example embodiment. The geothermal power plant system 1200 in FIG. 14 is different from the geothermal power plant system 1100 in FIG. 13 in that it includes the control valve 32. The other configurations of the geothermal power plant system 1200 in FIG. 14 may be the same as that of the geothermal power plant system 1100 in FIG. 13. The descriptions of labels common to FIG. 13 in FIG. 14 are omitted.

In the present example, the bottom controlling unit 94 controls the control valve 32. That is, the bottom controlling unit 94 may function as a flow velocity controlling unit. The bottom controlling unit 94 may control the swirling flow velocity of the heat source water 6 based on the deposit amount of the solid substances 9 deposited at the bottom 31 of the cyclone solid-liquid separation unit 30. For example, when the deposit amount of the solid substances 9 deposited at the bottom 31 of the cyclone solid-liquid separation unit 30 is equal to or greater than a defined value, the bottom controlling unit 94 reduces the opening degree of the control valve 32 and increases the swirling flow velocity of the heat source water 6. By increasing the swirling flow velocity of the heat source water 6, the solid substances 9 deposited at the bottom 31 of the cyclone solid-liquid separation unit 30 can be removed. Also, when the deposit amount of the solid substances 9 deposited at the bottom 31 of the cyclone solid-liquid separation unit 30 is equal to or less than the defined value, the bottom controlling unit 94 may increase the opening degree of the control valve 32 and reduce the swirling flow velocity of the heat source water 6.

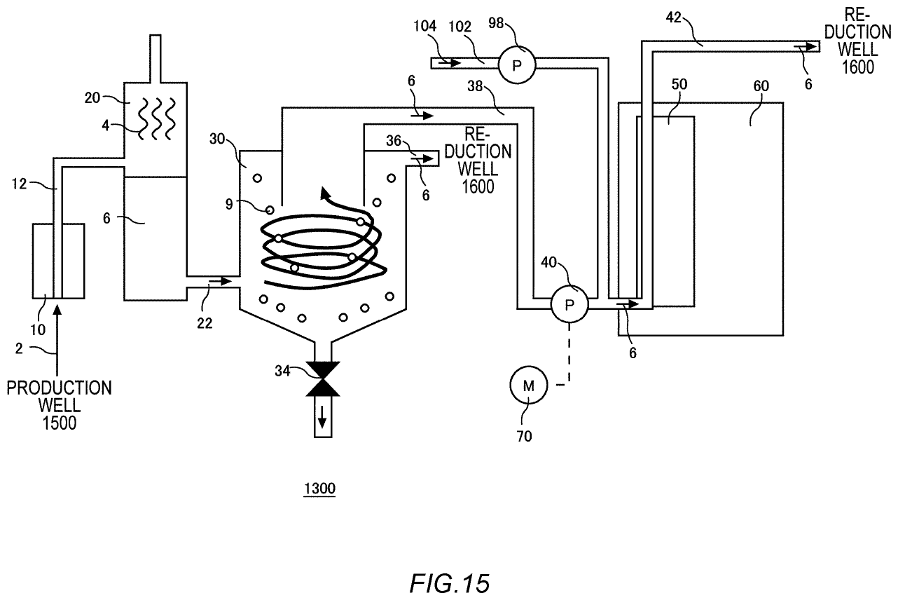

FIG. 15 illustrates an example of a geothermal power plant system 1300 during operation according to an example embodiment. The geothermal power plant system 1300 in FIG. 15 is different from the geothermal power plant system 200 in FIG. 2 in that it includes a chemical liquid injection pump 98 and an inhibitor feed unit 102. Also, the geothermal power plant system 1300 in FIG. 15 is different from the geothermal power plant system 200 in FIG. 2 in the point of not including the control valve 32, the flow velocity sensor 35 and the flow velocity controlling unit 52. The other configurations of the geothermal power plant system 1300 in FIG. 15 may be the same as that of the geothermal power plant system 200 in FIG. 2. The descriptions of labels common to FIG. 2 in FIG. 15 are omitted.

The inhibitor feed unit 102 feeds the inhibitor 104. The inhibitor feed unit 102 may be provided in the heat source water supply pipe 38. The inhibitor 104 may be a chemical liquid such as sulfuric acid for suppressing scale particles. The inhibitor 104 may be a chemical liquid, such as sodium hydroxide, that increases the saturated concentration of scale and reduces the supersaturation of scale. The inhibitor feed unit 102 may feed the inhibitor 104 by operating the chemical liquid injection pump 98. By feeding the inhibitor 104, the scale precipitation may be suppressed. The timing when the inhibitor 104 is fed may be the timing during operation or may be the timing when the operation is stopped.

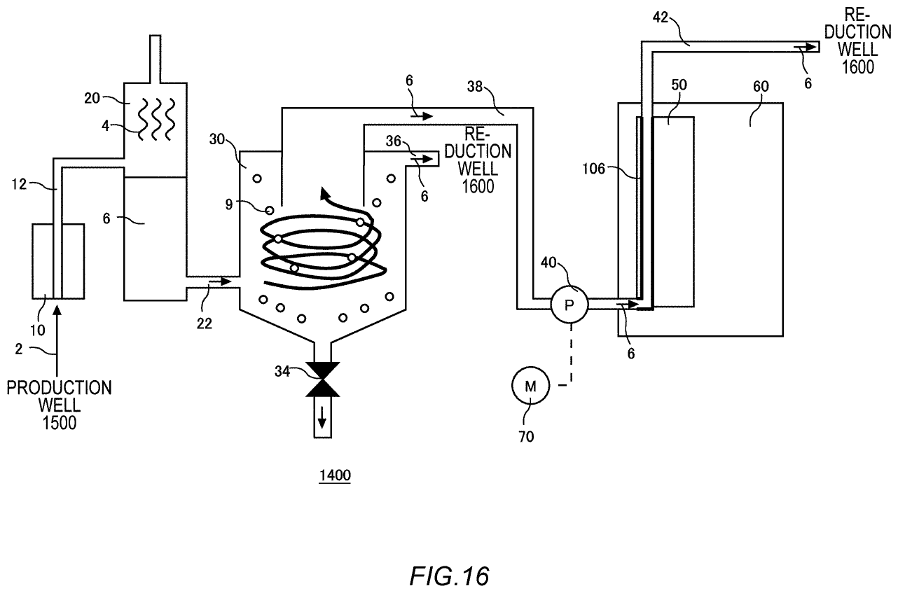

FIG. 16 illustrates an example of a geothermal power plant system 1400 during operation according to an example embodiment. The geothermal power plant system 1400 in FIG. 16 is different from the geothermal power plant system 200 in FIG. 2 in that it includes a low adhesion material 106. Also, the geothermal power plant system 1400 in FIG. 16 is different from the geothermal power plant system 200 in FIG. 2 in the point of not including a control valve 32, a flow velocity sensor 35 and a flow velocity controlling unit 52. Other configurations of the geothermal power plant system 1400 in FIG. 16 may be the same as that of the geothermal power plant system 200 in FIG. 2. The descriptions of labels common to FIG. 2 in FIG. 16 are omitted.

The low adhesion material 106 is provided inside of piping in the heat exchanging unit 50. The low adhesion material 106 is carbon steel or stainless steel as an example. The low adhesion material 106 may be resin or the like. By providing the low adhesion material 106 inside the pipe in the heat exchanging unit 50, the scale can be suppressed to adhere to the interior of the pipe of the heat exchanging unit 50.

While the embodiments of the present invention have been described, the technical scope of the present invention is not limited to the above-described embodiments. It is apparent to persons skilled in the art that various alterations or improvements can be made to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

2: geothermal fluid; 4: gaseous substances; 6: heat source water; 8: heat medium; 9: solid substances; 10: geothermal fluid supply unit; 12: geothermal fluid supply pipe; 20: gas-liquid separation unit; 22: heat source water supply pipe; 30: cyclone solid-liquid separation unit; 31: bottom; 32: control valve; 33: side wall; 34: control valve; 35: flow velocity sensor; 36: heat source water discharge pipe; 37: switching valve; 38: heat source water supply pipe; 39: temperature sensor; 40: water pump; 42: heat source water discharge pipe; 50: heat exchanging unit; 52: flow velocity controlling unit; 54: heat source water supply pipe; 55: control valve; 56: heat source water discharge pipe; 57: common portion; 58: control valve; 59: common portion; 60: binary power generation unit; 62: nozzle; 64: nozzle; 66: control valve; 68: control valve; 70: driving controlling unit; 72: nozzle controlling unit; 73: water pump; 74: spiral piping; 76: dual pipe; 78: thermally insulating material; 80: detergent feed unit; 81: detergent; 82: heating unit; 83: control valve; 84: loop controlling unit; 90: water pump; 92: connection tube; 94: bottom controlling unit; 96: stress sensor; 98: chemical liquid injection pump; 100: geothermal power plant system; 102: inhibitor feed unit; 104: inhibitor; 106: low adhesion material; 124: heat exchanging unit; 140: pump; 142: heat medium supply pipe; 144: heat medium recovery pipe; 146: heat medium feed unit; 148: heat source water discharge pipe; 150: evaporation unit; 160: binary power generation unit; 200: geothermal power plant system; 300: geothermal power plant system; 400: geothermal power plant system; 500: geothermal power plant system; 600: geothermal power plant system; 700: geothermal power plant system; 800: geothermal power plant system; 900: geothermal power plant system; 1000: geothermal power plant system; 1100: geothermal power plant system; 1200: geothermal power plant system; 1300: geothermal power plant system; 1400: geothermal power plant system; 1500: production well; 1600: reduction well.

What is claimed is:

1. A geothermal power plant system configured to generate power by treating heat source water, comprising:
a cyclone solid-liquid separation unit configured to separate solid substances inside the heat source water from the heat source water; and
a heat exchanging unit configured to perform heat exchange on the heat source water from the cyclone solid-liquid separation unit.

2. The geothermal power plant system according to claim 1, further comprising a gas-liquid separation unit configured to separate gaseous substances from the heat source water supplied to the cyclone solid-liquid separation unit.

3. The geothermal power plant system according to claim 1, further comprising a flow velocity controlling unit configured to control a swirling flow velocity of the heat source water supplied to the cyclone solid-liquid separation unit.

4. The geothermal power plant system according to claim 2, further comprising a flow velocity controlling unit configured to control a swirling flow velocity of the heat source water supplied to the cyclone solid-liquid separation unit.

5. The geothermal power plant system according to claim 3, further comprising:
a first pipe for supplying the heat source water; and
a second pipe for supplying the heat source water, which has a smaller pipe diameter than the first pipe,
wherein the flow velocity controlling unit controls a valve provided in the first pipe and a valve provided in the second pipe; and
wherein the second pipe is provided above the first pipe.

6. The geothermal power plant system according to claim 3, further comprising
a water pump, provided between the cyclone solid-liquid separation unit and the heat exchanging unit in a flow path of the heat source water, and configured to supply the heat source water to the heat exchanging unit,
wherein an operation of the water pump is controlled based on the swirling flow velocity of the heat source water.

7. The geothermal power plant system according to claim 5, further comprising
a water pump, provided between the cyclone solid-liquid separation unit and the heat exchanging unit in a flow path of the heat source water, and configured to supply the heat source water to the heat exchanging unit,
wherein an operation of the water pump is controlled based on the swirling flow velocity of the heat source water.

8. The geothermal power plant system according to claim 3, wherein
the flow velocity controlling unit is configured to control the swirling flow velocity of the heat source water based on a deposit amount of the solid substances deposited at a bottom of the cyclone solid-liquid separation unit.

9. The geothermal power plant system according to claim 5, wherein
the flow velocity controlling unit is configured to control the swirling flow velocity of the heat source water based on a deposit amount of the solid substances deposited at a bottom of the cyclone solid-liquid separation unit.

10. The geothermal power plant system according to claim 6, wherein
the flow velocity controlling unit is configured to control the swirling flow velocity of the heat source water based on a deposit amount of the solid substances deposited at a bottom of the cyclone solid-liquid separation unit.

11. The geothermal power plant system according to claim 1, further comprising
a loop controlling unit configured to control a valve in order to form a loop flow path including at least one of the heat exchanging unit or the cyclone solid-liquid separation unit.

12. The geothermal power plant system according to claim 2, further comprising
a loop controlling unit configured to control a valve in order to form a loop flow path including at least one of the heat exchanging unit or the cyclone solid-liquid separation unit.

13. The geothermal power plant system according to claim 3, further comprising
a loop controlling unit configured to control a valve in order to form a loop flow path including at least one of the heat exchanging unit or the cyclone solid-liquid separation unit.

14. The geothermal power plant system according to claim 11, wherein
the loop controlling unit is configured to control a valve in order to form the loop flow path including the heat exchanging unit, but not including the cyclone solid-liquid separation unit.

15. The geothermal power plant system according to claim 11, wherein
the loop controlling unit is configured to control a valve in order to form the loop flow path including both of the heat exchanging unit and the cyclone solid-liquid separation unit.

16. The geothermal power plant system according to claim 11, further comprising
a detergent feed unit, provided between the cyclone solid-liquid separation unit and the heat exchanging unit in a flow path of the heat source water, and configured to feed a detergent into the loop flow path.

17. The geothermal power plant system according to claim 14, further comprising
a detergent feed unit, provided between the cyclone solid-liquid separation unit and the heat exchanging unit in a flow path of the heat source water, and configured to feed a detergent into the loop flow path.

18. The geothermal power plant system according to claim 16, wherein
the detergent feed unit is configured to control an feed amount of the detergent based on a temperature of the heat source water discharged by the heat exchanging unit.

19. The geothermal power plant system according to claim 1, wherein
the cyclone solid-liquid separation unit is configured to control a discharge amount of the solid substance based on a deposit amount of the solid substances deposited at a bottom of the cyclone solid-liquid separation unit.

20. The geothermal power plant system according to claim 2, wherein
the cyclone solid-liquid separation unit is configured to control a discharge amount of the solid substance based on a deposit amount of the solid substances deposited at a bottom of the cyclone solid-liquid separation unit.
